(19) United States
(12) Patent Application Publication
(10) Pub. No.: US 2003/0090705 A1
(43) Pub. Date: May 15, 2003

(54) Providing print job accounting in a computer system configuration

(76) Inventor: Andrew R. Ferlitsch, Tigard, OR (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 10/010,112

(22) Filed: Nov. 13, 2001

(51) Int. Cl. B41J 1/00; B41F 1/00; G06F 15/00

(52) U.S. Cl. 358/1.15; 358/1.18

(57) ABSTRACT

Systems and methods for providing print job accounting in a computer system configuration. A user at a computer device initiates a print job that is to be printed at a printing device. Prior to despooling any print data to the printing device, the user and user account information are authenticated and the cost for consumables, such as paper and toner, are determined. If sufficient funds exist in the user's account, the determined amount is charged to the user's account and the print data is despooled to the intended printer from either a client or server of the computer system.

### 1. RELATED APPLICATIONS

This application claims priority to U.S. patent application Ser. No. 09/681,409 filed Mar. 30, 2001, entitled “METHODS AND SYSTEMS FOR PRINT-PROCESSOR-BASED PRINTER STATUS DETECTION AND PRINT TASK DISTRIBUTION,” and to U.S. patent application Ser. No. 09/681,416 filed Mar. 30, 2001, entitled “METHODS AND SYSTEMS FOR PRINT-PROCESSOR-BASED PRINT TASK ERROR RECOVERY,” both of which claim priority to U.S. patent application Ser. No. 09/681,208 filed Feb. 22, 2001, entitled “METHODS AND SYSTEMS FOR PRINT-PROCESSOR-MODIFIED PRINTING,” which claims priority to U.S. Provisional Patent Application Serial No. 60/261,132 filed Jan. 11, 2001, entitled “METHODS AND SYSTEMS FOR PRINT-PROCESSOR-MODIFIED PRINTING.”

### BACKGROUND OF THE INVENTION

1. Field of the Invention

The present invention relates to printing a document in a computer system configuration. More particularly, the present invention relates to systems and methods for providing print job accounting in a computer system configuration, wherein a cost for a particular print job that is initiated by a computer device and subsequently sent to an available printing device is calculated prior to despooling the print data to the printing device.

2. Background and Related Art

With the emergence of software and hardware components of computer systems, users are able to employ the computer systems to perform a variety of tasks. For example, a user may utilize a software application, such as a word processor, spreadsheet, or other application, to create a file or document. Once created, the document may be printed on a local, remote, or network printing device.

At times it may be advantageous to charge an amount for each print job processed at a printing device. As such, traditional methods that enable the accounting of print jobs have utilized the firmware of the printing device. One method charges the amount after a job is printed and includes a key device that is obtained from an operator and is inserted into a slot of a printer to engage the printer to process a print job. The key includes a counter that counts the number of sheets of paper that are consumed by the print job. The user may use the key to process one or more print jobs, and then return the key to the operator. The user is then charged on a per page basis for the processed print jobs. While this method allows for the accounting of and charge for print jobs, the method requires the use of an operator to provide the key devices to users and to record, reset and/or otherwise maintain the counter for each of the key devices. Furthermore, this method requires each user to obtain a key device, which increases the amount of time required for a user to have one or more print jobs processed. The amount of time required is further extended when a particular user is required to wait while another user uses a particular key, wait while the other user pays for the print jobs performed using the key, and wait while an operator records and/or resets the counter of the key in order for the particular user to be able to use the key to process his/her print jobs.

Another method employs a card swipe system that is coupled to a printer. With the card swipe system, a user accesses his/her account by swiping a card issued to the user. The swiping of the card verifies the authenticity of the card and accesses the user's account in order to engage the printer to process print jobs. Upon completion of the print jobs, the user's account is charged for the print jobs. While this approach also allows for the accounting of print jobs, it requires the user to activate the printing of the print job at the card swipe system. The user is typically required to be physically present at the card swipe system when the print job is initiated in order to swipe the card. Furthermore, the method requires the card to be swiped for each print job and can result in cards that are unreadable or otherwise defective. Moreover, the charging of the amount for the print job doesn't support a pre-paid debit system.

### SUMMARY OF THE INVENTION

The present invention relates to printing a document in a computer system configuration. More particularly, the present invention relates to systems and methods for providing print job accounting in a computer system configuration, wherein a cost for a particular print job that is initiated by a computer device and subsequently sent to an available printing device is calculated prior to despooling the print data to the printing device.

Implementation of the present invention takes place in association with a computer system configuration that includes a computer device and a printer. In one implementation the computer device is a client and the system further includes a network and optionally a server. A user at the client initiates a print job that represents the printing of one or more documents. The documents may include one or more pages, and may collectively include one or more copies. Upon initiating the print job, a user at the client selects a command or a sequence of commands that indicate that the user intends to despool the corresponding print data to the printer. However, prior to despooling the print data to the printer, the user and account information are authenticated and the cost for consumables (e.g., paper, toner, etc.) of the print job is determined. If there exist sufficient finds in the user's account, the account is charged and the print data is despooled to the one or more printers from either a client or from a server of the computer system.

When the print data is despooled from a client, the print instructions corresponding to the print job may be in a journaled (e.g., an enhanced metafile format) or a printer ready (e.g., a raw or unprocessed) format. A client-side spooler and/or a client-side print processor is used in authenticating the user and account information, in parsing spool data to determine the amount to charge for the print job, and in charging the determined amount to the user's account.

Similarly, when the print data is despooled from a server, the print instructions corresponding to the print job may be in a journaled format or in a printer ready format. A server-side spooler and/or a server-side print processor is used in authenticating the user and account information, in parsing spool data to determine the amount to charge for the print job, and in charging the determined amount to the user's account. Alternatively, a client-side print processor may perform the print job accounting when the print processor is invoked.

In one implementation, the printing device is locally connected to the computer device. A user of the computer device initiates a print job that is to be printed at the locally connected printing device. Prior to despooling the print data to the printing device, the user and account information are authenticated and the cost for consumables of the print job is determined. If sufficient finds exist in the user's account, the account is charged and the print data is despooled to the printing device.

While the methods and processes of the present invention have proven to be particularly useful in the area of print job accounting, those skilled in the art can appreciate that the methods and processes can be used on a variety of different applications to charge for or otherwise track consumables used.

Additional features and advantages of the present invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order that the manner in which the above recited and other advantages and features of the invention are obtained, a more particular description of the invention briefly described above will be rendered by reference to specific embodiments thereof, which are illustrated in the appended drawings. Understanding that these drawings depict only typical embodiments of the invention and are not, therefore, to be considered to be limiting of its scope, the invention will be described and explained with additional specificity and detail through the use of the accompanying drawings in which:

FIG. 1 illustrates an exemplary system that provides a suitable operating environment for use of the present invention;

FIG. 2 illustrates a representative networked system configuration that may be used in association with the present invention;

FIG. 3A provides a flow chart that illustrates an embodiment for providing client-based print job accounting that utilizes journaled data in accordance with the present invention;

FIG. 3B provides an example of parsing spool data in relation to the embodiment of FIG. 3A;

FIG. 3C provides a flow chart that illustrates an embodiment for providing client-based print job accounting that utilizes raw data in accordance with the present invention;

FIG. 3D provides an example of parsing spool data in relation to the embodiment of FIG. 3C;

FIG. 4A provides a flow chart that illustrates an embodiment for providing server-based print job accounting that utilizes journaled data in accordance with the present invention;

FIG. 4B provides an example of parsing spool data in relation to the embodiment of FIG. 4A;

FIG. 4C provides a flow chart that illustrates an embodiment for providing server-based print job accounting that utilizes raw data in accordance with the present invention; and

FIG. 4D provides an example of parsing spool data in relation to the embodiment of FIG. 4C.

### DETAILED DESCRIPTION OF THE INVENTION

The present invention relates to printing a document in a computer system configuration. More particular, the present invention relates to systems and methods for providing print job accounting in a computer system configuration, wherein a cost for a particular print job that is initiated by a computer device and subsequently sent to an available printing device is calculated prior to despooling the print data to the printing device.

In the disclosure and in the claims, the term “consumable” or “consumables” shall refer to goods that are to be used or otherwise expended in order to process a print job. Examples of such consumables include the amount and type of paper and ink expended by a print job, the amount and type of binding materials used, such as staples, stitching, etc., and the type of print, such as black and white versus color printing. Embodiments of the present invention take place in association with a computer system configuration that includes a computer device and a printer. In one embodiment, the computer device is a client and the system further includes a network and optionally a server. A user at a computer device initiates a print job. Prior to despooling the print data to the printer, the user and account information is authenticated and the cost for consumables of the print job is determined. If there exist sufficient funds in the user's account, the account is charged the determined amount and the print data is despooled to the printer, as will be discussed below.

The following disclosure of the present invention is grouped into three subheadings, namely “Exemplary Operating Environment,” “Client-Based Print Job Accounting,” and “Server-Based Print Job Accounting.” The utilization of the subheadings is for convenience of the reader only and is not to be construed as limiting in any sense.

### Exemplary Operating Environment

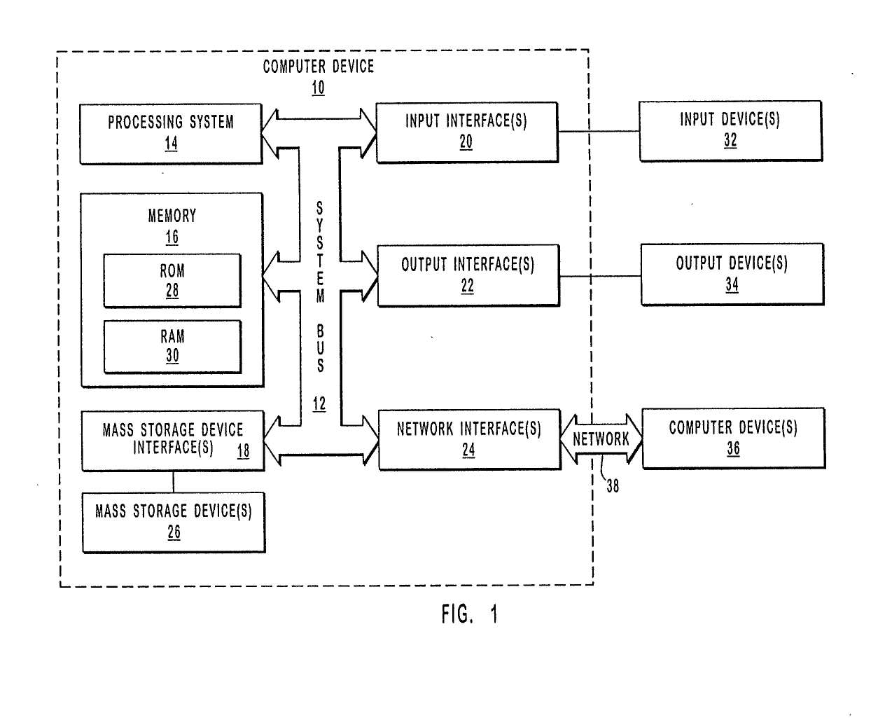

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer-readable media, wherein each medium may be configured to include or includes thereon data or computer-executable instructions for manipulating data. The computer-executable instructions include data structures, objects, programs, routines, or other program modules that may be accessed by a processing system, such as one associated with a general-purpose computer capable of performing various different functions or one associated with a special-purpose computer capable of performing a limited number of functions. Computer-executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), a wireless interface, such as a bluetooth or radio frequency interface, or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

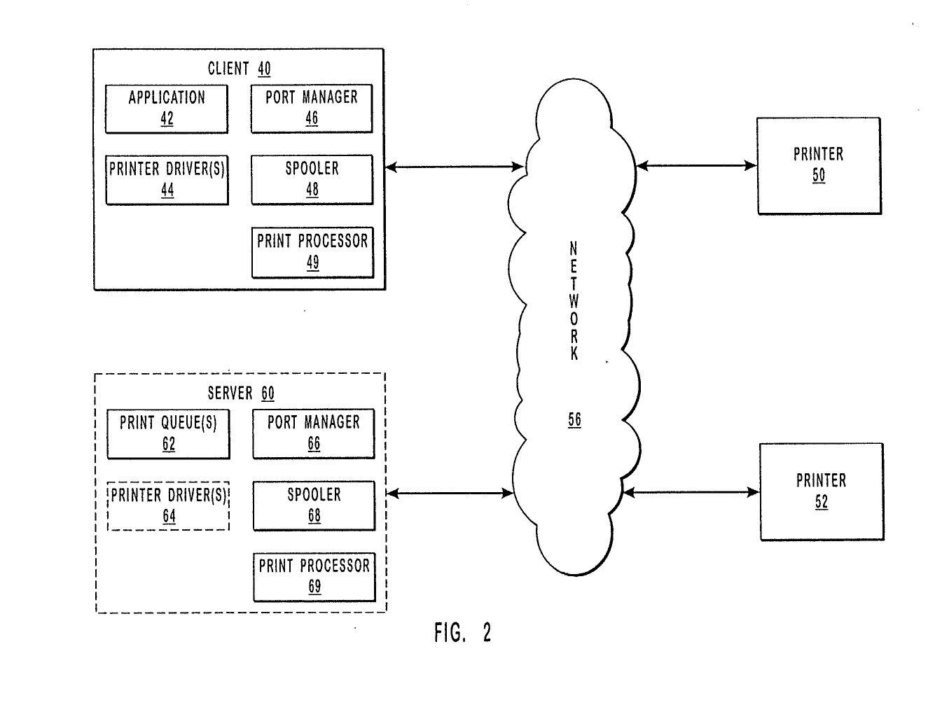

While those skilled in the art will appreciate that the invention may be practiced in networked computing environments with many types of computer system configurations, FIG. 2 represents a representative networked system configuration that may be used in association with the present invention. While FIG. 2 illustrates an embodiment that includes a client, two printers, and optionally a server connected to a network, alternative embodiments include more than one client, only one printer, more than two printers, no server, and/or more than one server connected to a network, and one or more computer devices locally connected to one or more printing devices. Moreover, embodiments in accordance with the present invention also include a multitude of clients throughout the world connected to a network, where network is a wide area network, such as the Internet.

The representative system of FIG. 2 includes a computer device, illustrated as client 40, which is connected to a plurality of printing devices, illustrated as printers 50 and 52, across network 56. While printers 50 and 52 are connected to network 56, embodiments of the present invention embrace the use of one or more printing devices that are locally connected to a computer or that are configured in a peer-to-peer printing environment.

Client 40 includes a software application 42, one or more print drivers 44, a port manager 46, a spooler 48, and a print processor 49. Client 40 may be configured to authenticate the user initiating a particular print job, determine the consumables that will be used by the print job, determine if the user has sufficient credit in a printing account for the consumables, and initiate or deny the despooling of the print data representing the print job to one or more printing devices, such as printers 50 and 52, as will be further discussed below.

Server 60 includes one or more print queues 62, one or more printer drivers 64, a port manager 66, a spooler 68, and a print processor 69. Server 60 is capable of initiating a print job and of despooling the job to spooler 68, and optionally to print processor 69, and then to one or more compatible printers 50 and 52, as will be further discussed below.

In accordance with the present invention, a user initiates a print job, typically from a software application 42 or by an automated or background process. Upon initiating a print job, the user selects a command or a sequence of commands that indicates the user's intent to despool the print data to one or more printing devices. As will be discussed below, embodiments of the present invention embrace providing print job accounting in the system prior to despooling print data from a client or from a server to a printing device.

Client-Based Print Job Accounting

When print data is to be despooled from a client, the print instructions corresponding to the print job may be in a journaled (e.g., an enhanced metafile format) or in a printer-ready (e.g., a raw or unprocessed) format. A client-side spooler and/or a client-side print processor may be used in authenticating user and account information, in parsing spool data to determine the amount to charge for the print job, and in charging the determined amount to the user's account.

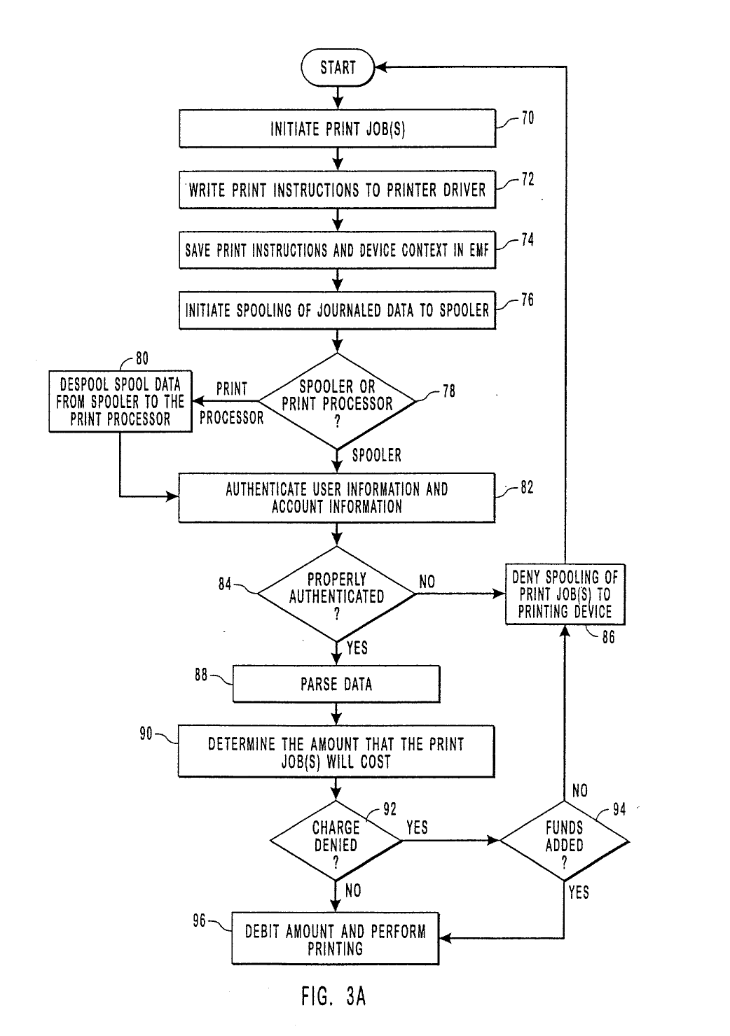

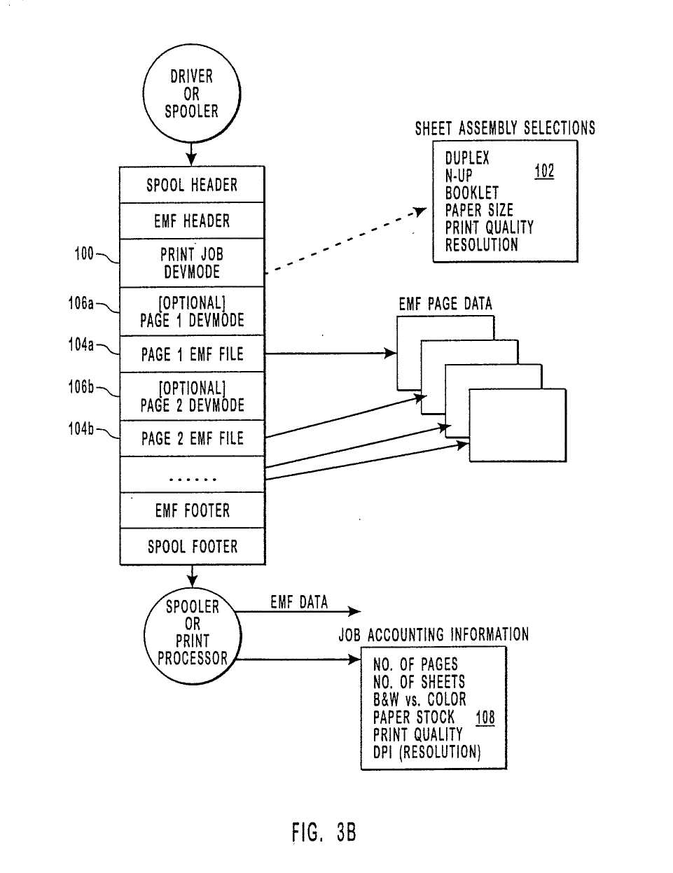

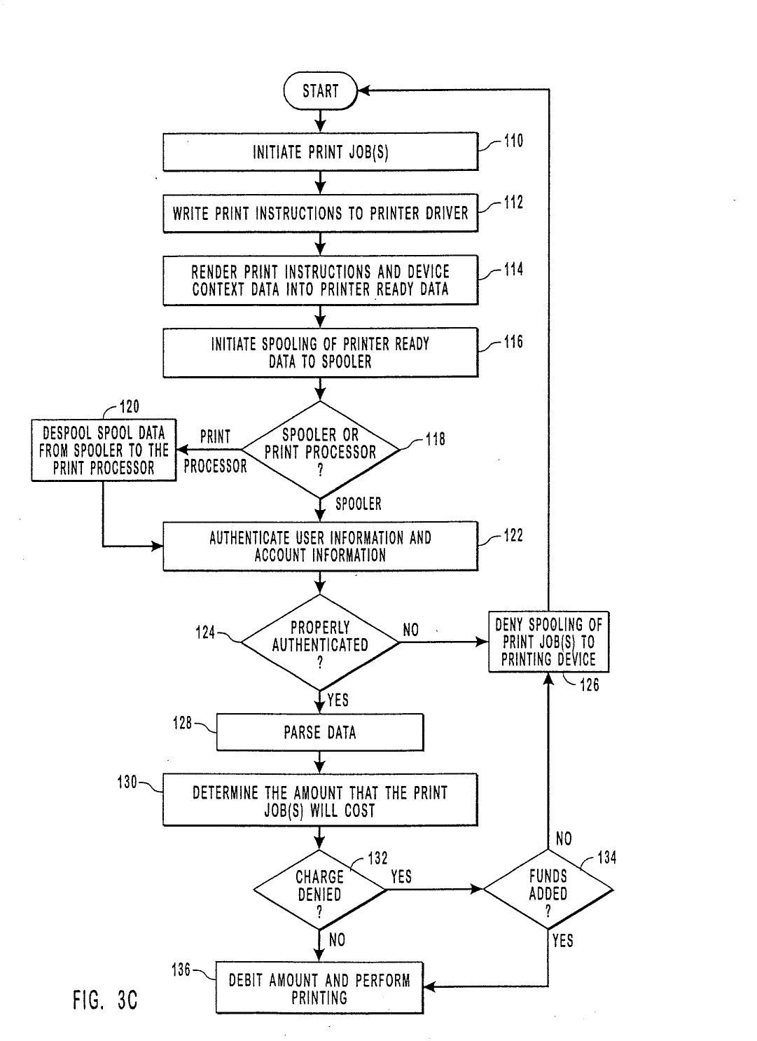

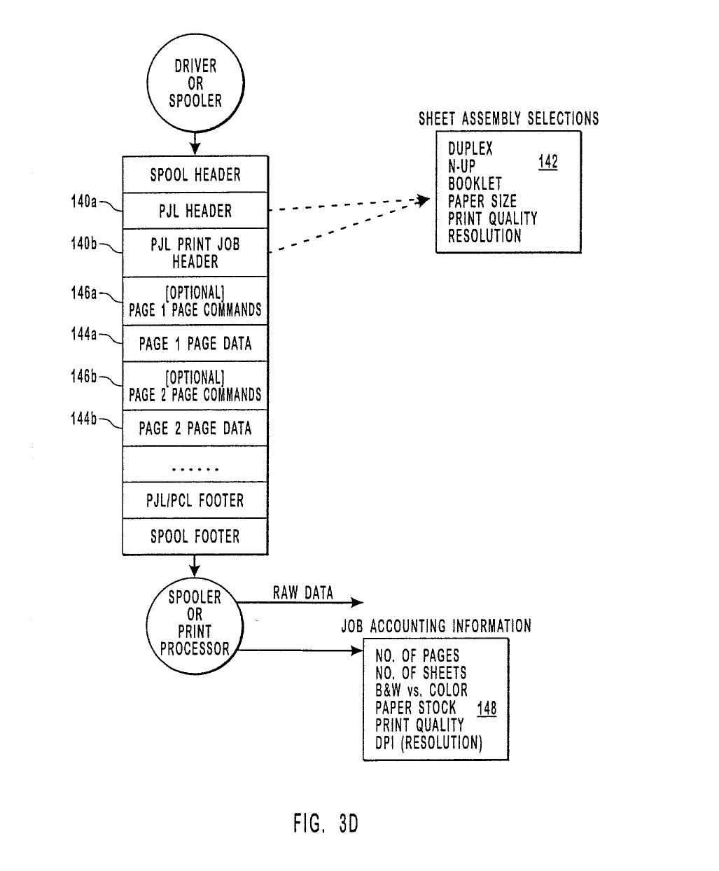

With reference to FIG. 3A, a flow chart is provided that illustrates an embodiment for providing client-based print job accounting that utilizes journaled data. In FIG. 3A, execution begins at step 70, where one or more print jobs are initiated. A print job is typically initiated by a software application, such as application 42 of FIG. 2. Once initiated, the software application or another application writes the print instructions to a printer driver at step 72. The print instructions may be rendered in journaled data for deferred rendering. By way of example, in the Microsoft® family of operating systems, the print instructions may be written to a graphical display interface with one or more of the device contexts of corresponding printing devices. Such print instructions are then passed to the one or more corresponding printer drivers. When the data is journaled, the one or more printer drivers save the print instructions and device context in, for example, an enhanced metafile format at step 74. The one or more printer drivers then spool the journaled data to the client spooler at step 76.

Upon initiating the spooling of the print job at step 76, a determination is made at decision block 78 as to whether to employ the client-side spooler and/or print processor to authenticate, to parse data, and to perform account charging. Therefore, if it is determined at decision block 78 that only the spooler will be used, execution proceeds directly to step 82. Alternatively, if it is determined that the print processor will be used, execution proceeds to step 80, where the spool data is despooled from the spooler to the print processor, and then to step 82.

At step 82, the user information and the user's account information is authenticated. By way of example, in one embodiment the spooler or print processor displays a dialog to the user that allows the user to enter or otherwise provide account information, account identification, a password, and/or other accounting and/or security information. In another embodiment, a printer driver authenticates the user information and the user's account information. The authentication and account information is then passed to the spooler or print processor, such as by embedding the information in the spool data, by providing or otherwise utilizing an applied program interface (“API”) call, by utilizing a memory or disk location, such as a file in a spool directory, by utilizing one or more keys or fields in a registry, or by another process that passes the information to the spooler or print processor. In an alternative embodiment, the spooler or print processor uses the user identification of the current user of the computing device as the account user identification and obtains account information from a predetermined location, such as from the registry or network database, by using the user identification as a key.

A determination is then made at decision block 84 as to whether or not the user and account information was properly authenticated. If it is determined at decision block 84 that the information is not properly authenticated, the spooling of the print job to the specified printing device is denied at step 86. Alternatively, if it is determined at decision block 84 that the information is properly authenticated, execution proceeds to step 88, where the spool data is parsed to determine the physical layout (e.g., the sheet assembly, the finishing options, such as stapling or stitching, the paper stock, such as 24 or 60 pound paper stock, the transparency, and the ink, such as black and white or color) and the number of pages of the print job.

With reference to FIG. 3B, an example for parsing journaled spool data is provided. In FIG. 3B, the spool data includes a print job DEVMODE 100 that describes the overall sheet assembly requirements or selections of the particular print job. As illustrated by box 102, the sheet assembly selections may include, but are not limited to, duplex, n-up, booklet, and paper size. The print job DEVMODE 100 may contain other information, such as the amount of ink that may be consumed by the print job and/or the print quality and resolution (e.g. dpi) of the print job.

The remainder of the spool data is parsed for the journaled page data, obtained from the EMF file 104 for each page of the print job, and the optional page specific DEVMODEs 106, which may change the sheet assembly characteristics of the print job. For example, in a ten-page job, the print job DEVMODE may indicate duplex for pages 1-6 and simplex for pages 7-10. Therefore, without considering other sheet assembly factors, this would require three sheets of paper for the first six pages (duplex or “double-sided”) and four sheets of paper for the remaining four pages (simplex or “one-sided”).

When utilizing one of the Microsoft Windows® 9X family of operating systems, the EMF page data is located in a separate file, one file per page. The spool data file contains a pathname to each EMF page data file in their logical order. Thus, counting up the number of EMF pathnames makes a determination as to the total number of pages for a particular print job.

Referring back to FIG. 3A, once the data is parsed at step 88, execution proceeds to step 90 to determine the amount that the print job will cost. A variety of factors may be used to determine the amount. For example, box 108 of FIG. 3B provides various examples of job accounting factors or information, such as the number of pages, number of sheets, use of black toner, use of color toner, paper stock, print quality, resolution (e.g. dpi), and the like. Once the accounting information is calculated, a determination is made at decision block 92 as to whether or not the amount that the user's account is to be charged for the print job will be denied for a lack of funds. If it is determined at decision block 92 that the charge is denied, the user may be given an opportunity to add finds to his/her account. Therefore, if it is determined at decision block 94 that additional finds were not added, the spooling of the print job is denied at step 86, and execution returns back to start. Alternatively, if it is determined at decision block 94 that additional funds were added, execution proceeds to step 96 for the charging of the user's account for the print job(s) and the performance of the printing, which may include spooling the print job(s) to the print processor or port manager.

Returning back to decision block 92, if it is determined that a charge to the user's account will not be denied, execution proceeds directly to step 96, where the user's account is charged or otherwise debited and the job is printed.

While FIGS. 3A and 3B provide an example for client-side print job accounting that uses journaled data, embodiments of the present invention also embrace client-side print job accounting that uses printer-ready data. One such example is illustrated by the flow chart of FIG. 3C.

In FIG. 3C, execution begins at step 110, where one or more print jobs are initiated. Once initiated, a software application or other process writes the corresponding print instructions to a printer driver at step 112. The print instructions may be rendered in printer-ready data. In the Microsoft® family of operating systems, for example, the print instructions are written to the graphical display interface with the device context(s) of the one or more printing devices. The print instructions are passed to the corresponding printer drivers. In the case of printer-ready data, the printer driver renders the print instructions and device context in printer-ready data (e.g., PCL, Postscript, PDF, rasterized, etc) at step 114. At step 116, the printer driver spools the printer-ready data to the Spooler.

At decision block 118, a determination is made as to whether to employ the client-side spooler and/or print processor to authenticate, to parse data, and to perform account charging. Therefore, if it is determined at decision block 118 that the print processor is to be used, execution proceeds to step 120, where the spool data is despooled from the spooler to the print processor. Execution then proceeds to step 122. Alternatively, if it is determined at decision block 118 that only the spooler is to be used, execution proceeds directly to step 122.

At step 122, the user and account information is authenticated. In one embodiment, the spooler or print processor displays to the user at the client a dialog, to allow the user to enter account information, account identification, a password, and/or other accounting and/or security information. In another embodiment, the printer driver authenticates the user and account information, and passes down the authentication and account information to the spooler or print processor by one of variety of manners, such as by embedding the information in the spool data, by employing an API call(s), by placing the information in a memory or disk location such as in a file in the spool directory, or by utilizing keys/fields in the registry. In another embodiment, the spooler or print processor uses the user identification of the current user of the client as the account user identification and obtains account information from a predetermined location, such as from the registry or network database, using the user identification as a key.

At decision block 124 a determination is made as to whether or not the information has been properly authenticated. If it is determined that the information has not been properly authenticated, the spooling of the print job(s) to the printing device is denied at step 126 an execution returns back to start. Alternatively, if it is determined at decision block 124 that the information has been properly authenticated, execution proceeds to step 128, where the spool data is parsed to determine the print job physical layout, the number of pages, and other consumable information that are part of the print job.

In the case of raw data, and with reference to FIG. 3D, the spool data contains a sequence of print job commands 140 (e.g. in a PJL, PCL, Postscript, or other format) that describe the overall sheet assembly selections or requirements of the print job. Examples of such sheet assembly selections are provided in box 142, which include but are not limited to, duplex, n-up, booklet, and paper size. Furthermore, the sequence of print job commands may contain additional information on the amount of ink that may be consumed by the print job(s), illustrated in box 142 as the print quality and resolution (i.e., dpi).

The reminder of the spool file is parsed for the page description language (“PDL”) specific page data 144a and 144b and optional page specific page commands 146a and 146b. The page specific page commands may change the sheet assembly characteristics of the print job. For example, in a ten-page job, the print job commands may indicate duplex (“doublesided”) for pages 1-6, but the page specific page commands for pages 7-10 indicates simplex (“single-sided”). Without considering other sheet assembly factors, this would require three sheets of paper for the first six pages (duplex) and four sheets of paper for the remaining four pages (simplex).

In the case of page description language, such as PCL, Postscript and PDF, the page data is parsed to identify the number of data sequences or print commands that will result in an explicit page boundary (e.g., form feed) or an implicit page boundary (e.g., page orientation change) page boundary. The total number of pages is then determined by counting up the number of page boundaries. As indicated by box 148 of FIG. 3D, a user's account may be charged for a variety of consumable factors, such as the number of pages, the number of sheets, the type of toner used, the paper stock, the print quality, the resolution, or another factor.

With reference back to FIG. 3C, once the spool data has been parsed at step 128, execution proceeds to step 130 to determine the amount that the print job will cost. A determination is made at decision block 132 as to whether or not the amount will be denied. If the amount will be denied, the user may be provided an opportunity to provide additional funds to cover the costs. If it is determined at decision block 134 that the additional funds were not added, the spooling is denied at step 126 and execution returns back to start. Alternatively, if it is determined at decision block 134 that the additional finds were added or at decision block 132 that the charge will not be denied, execution proceeds to step 136, where the cost of the print job(s) is charged or otherwise debited from the user's account and the job is spooled and printed.

Server-Based Print Job Accounting

Embodiments of the present invention also allow for the despooling of print data from a server to one or more printing devices. When the print data is despooled from a server, the print instructions corresponding to the print job may be in a journaled format or in a printer ready format. A sever-side spooler and/or a server-side print processor may be used in authenticating the user account information, in parsing spool data to determine the account to charge for the print job, and in charging the determined amount to the user's account.

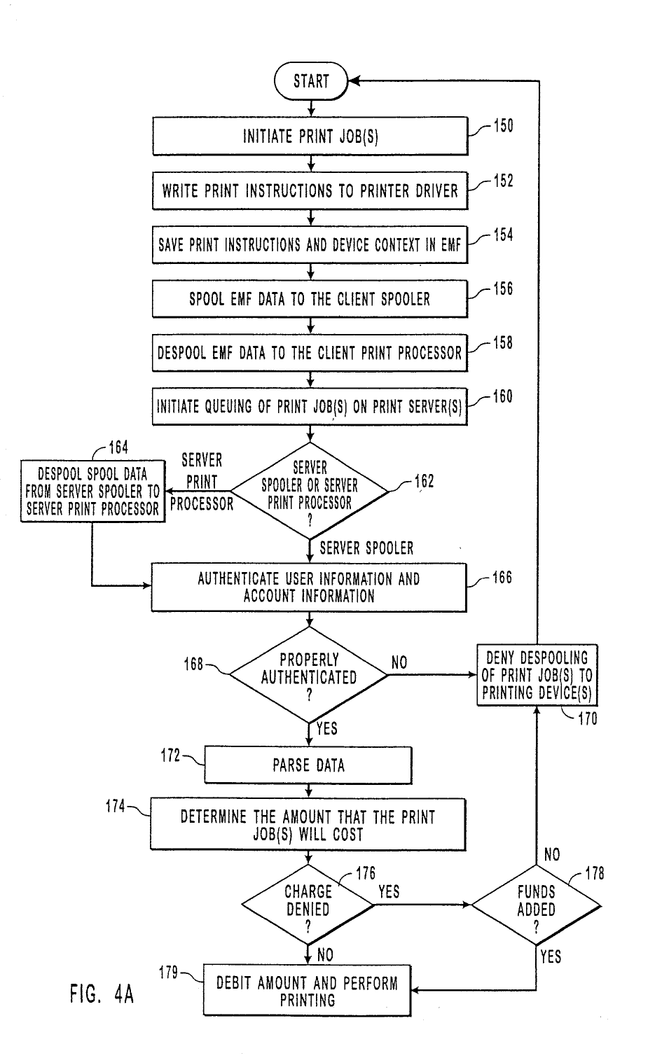

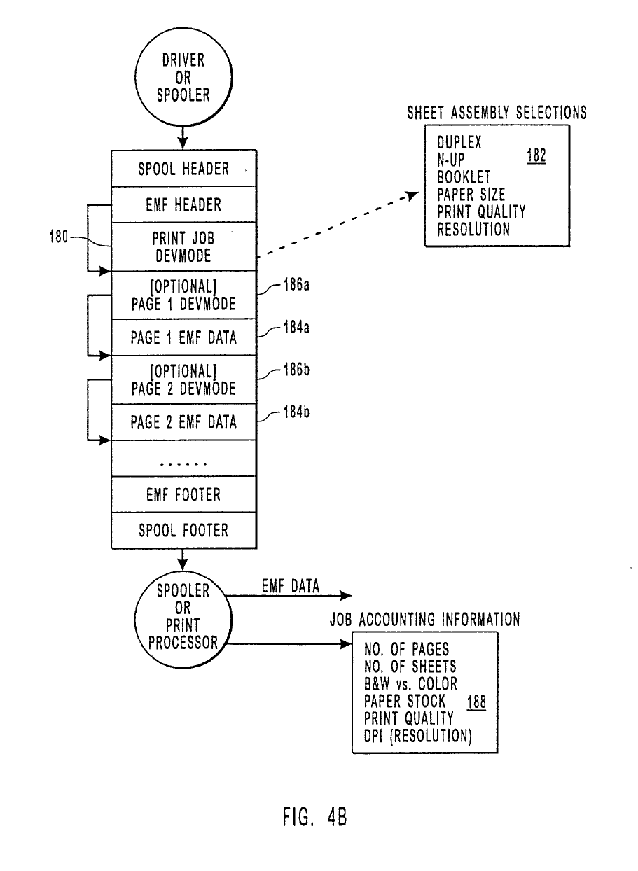

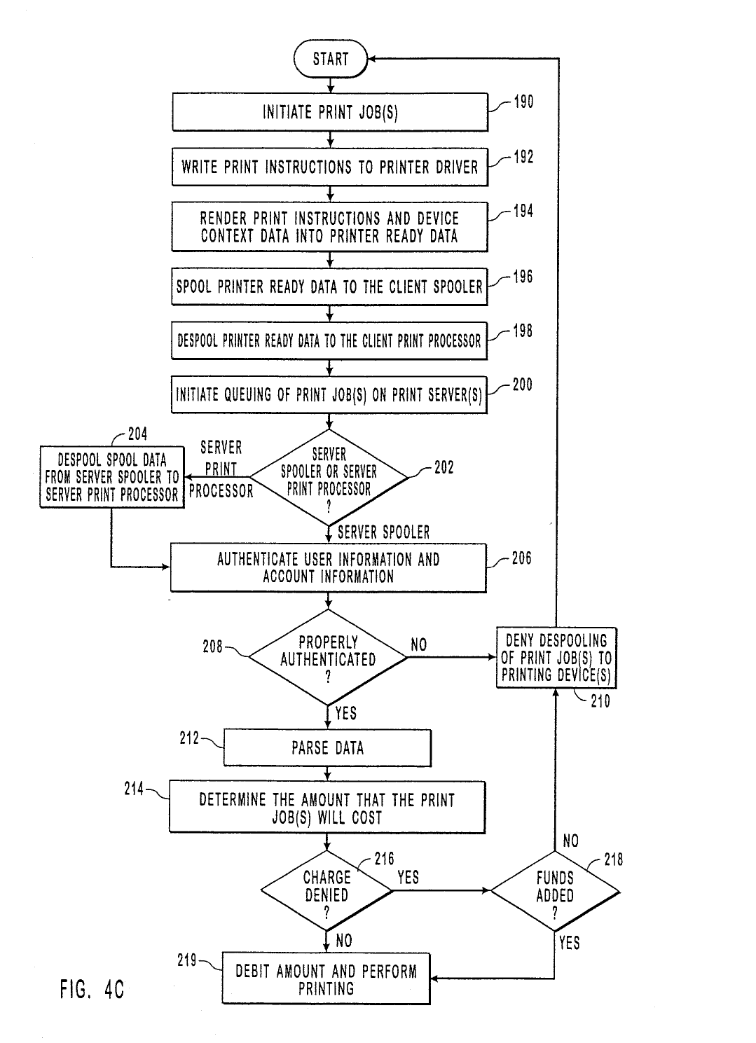

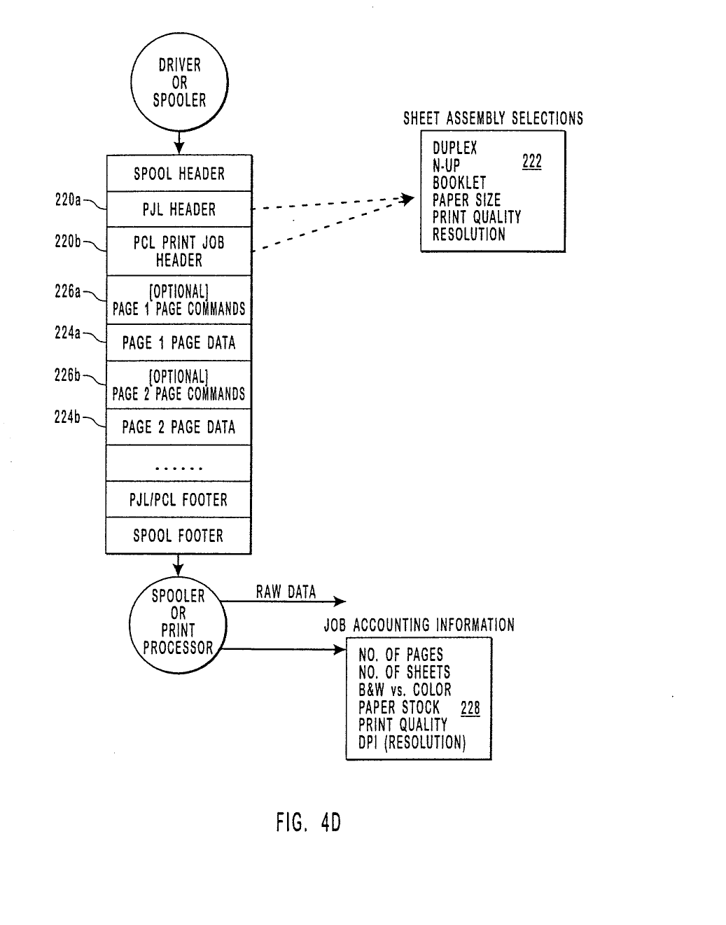

With reference to FIG. 4A, a flow chart is provided that illustrates an embodiment for providing server-based printing that utilizes journaled data. In FIG. 4A, execution begins at step 150, where one or more print jobs are initiated by the use of a software application or other process. After initiation of the print job(s), the application or other process writes the print instructions to a printer driver at step 152. The print instructions may be rendered in journaled data for deferred rendering. By way of example, in the Microsoft® family of Operating Systems, the print instructions are written to the graphical display interface with the device context(s) of the printing device(s). The print instructions are then passed to the corresponding printer driver(s). In the case of journaled data, the printer driver saves the print instructions and device context in an enhanced metafile format (“EMF”) at step 154. At step 156, the printer driver spools the journaled/EMF data to the spooler. At step 158, the spooler despools the journaled/EMF data to the print processor. In the case of a network printer, the EMF data is despooled to the print server(s), which manages the print queue(s) associated with the targeted printing device(s). The queuing of the print job(s) on the print server(s) is initiated at step 160.

Upon initiation of the queuing of the print job(s) on the print server, a determination is made as to whether to utilize the server-side spooler and/or the server-side print processor to authenticate, parse data, and/or perform account charging. If it is determined that the server print processor is to be employed, execution proceeds to step 164 to despool the spool data from the server spooler to the server print processor. Execution then proceeds to step 166. Alternatively, execution proceeds directly to step 166.

At step 166, the print server spooler or print processor authenticates the user and account information. In one embodiment, the spooler or print processor displays to the user a dialog, via a remote procedure call where the user is allowed to enter account information, account identification, a password, and/or other accounting and/or security information. In another embodiment, the client spooler or print processor authenticates the user and account information. In another embodiment, the printer driver authenticates the user and account information. The authentication and account information is then passed down to the spooler and/or the print processor by a variety of manners, such as by being embedded in the spool data by an API call(s), or by being placed in a memory or disk location such as a file in the spool directory, or by utilizing keys or fields in the registry. In another embodiment, the client and/or server spooler or print processor uses the user identification of the current user of the computing device as the account user identification and obtains account information from a predetermined location, such as the registry or network database, using the user identification as a key.

At decision block 168, a determination is made as to whether or not the information has been properly authenticated. If it is determined at decision block 168 that the information has not been properly authenticated, the despooling of the print job(s) to the printing device(s) is denied at step 170 and execution returns back to start. Alternatively, if it is determined at decision block 168 that the information has been properly authenticated, execution proceeds to step 172 for the parsing of spool data. The spool data is parsed to determine the physical layout and other consumable information relevant to the print job.

In the case of journaled or EMF data, and with reference to FIG. 4B, the spool data contains a print job DEVMODE 180 that describes the overall sheet assembly requirements or selections of the print job. Examples of such sheet assembly selections are provided in box 182 and include, but are not limited to, duplex, n-up, booklet, and paper size. The Print Job DEVMODE 180 may contain additional information on the amount of ink that may be consumed by the print job(s), such as the print quality and resolution (e.g., dpi).

The remainder of the spool file is parsed for the EMF page data 184a and 184b and optional page specific DEVMODE 186a and 186b, which may change the sheet assembly characteristics of the print job. In the case of the Microsoft Windows® NT/2K family of operating systems, the EMF page data is embedded in the spool data file. The spool data file contains a linked index to the file offset of the start of each EMF data per page. Traversing and counting up the number of EMF page file offset links is determines the total number of pages of the print job(s).

With reference back to FIG. 4A, once the spool data is parsed at step 172, the amount that the print job(s) will cost is determined at step 174. Once the accounting information is calculated, a determination is made at decision block 176 as to whether or not the charge will be denied due to a lack of funds in the user's account. If it is determined that the amount will be denied, the user may be given an opportunity to provide additional funds to cover the cost. Thus, a determination is made at decision block 178 as to whether or not additional funds were added. If no additional funds were added, the despooling is denied at step 170 and execution returns back to start. Alternatively, if it is determined at decision block 178 that additional funds were added or that the charge was not denied at decision block 176, execution proceeds to step 179 for the debiting of the amount of the print job(s) from the user's account and the spooling of the job(s) to the server print processor or port manager and the printing of the job(s).

With reference now to FIG. 4C, a flow chart is provided that illustrates an embodiment for providing server-based print job accounting that utilizes printer-ready data in accordance with the present invention. In FIG. 4C, execution begins at step 190, where one or more print jobs are initiated, and then to step 192 where the software application or other process used to initiate the print job(s) writes the print instructions to a printer driver. The print instructions may be rendered into printer-ready data (i.e., raw or unprocessed) at step 194. The print instructions are then passed to the corresponding printer driver(s). In the case of raw data, the printer driver renders the print instructions and device context into printer-ready data (e.g., PCL, Postscript, PDF, rastetrized) at step 194. The printer driver then spools the printer-ready data to the spooler at step 196, and at step 198 the spooler despools the printer-ready data the client print processor. In the case of a network printer, the raw data is despooled to the print server(s), which manages the print queue(s) associated with the targeted printing device(s). Upon initiation of the queuing of the print job(s) on the print server(s) at step 200, a determination is made at decision block 202 as to whether or not the server-side print processor and/or the server-side spooler is to be used to authenticate, parse, and/or charge a user's account. If it is determined at decision block 202 that the server-side print processor is to be used, execution proceeds to step 204, where the spool data is despooled from the server spooler to the server print processor, and then to step 206. Alternatively, execution proceeds directly to step 206.

At step 206, the user and account information is authenticated. In one embodiment, the spooler or print processor displays to the user a dialog via a remote procedure call to allow the user to enter account information, account identification, a password, and/or other accounting and/or security information. In another embodiment, the client spooler or print processor authenticates the user and account information. In another embodiment, the printer driver authenticates the user and account information. The authentication and account information is then passed down to the client and/or server spooler or print processor, such as by embedding the information in the spool data, by using an API call, or by placing the information in a memory or disk location such as a file in the spool directory, or by using keys or fields in the registry. In another embodiment, the client and/or server spooler or print processor uses the user identification of the current user of the computing device as the account user identification and obtains account information from a predetermined location, such as the registry or the network database, using the user identification as a key.

At decision block 208, a determination is made as to whether or not the information has been properly authenticated. If it is determined that the information has not been properly authenticated, execution proceeds to step 210, where the despooling of the print job(s) to the printing device(s) is denied and execution returns back to start. Alternatively, if the information has been properly authenticated, execution proceeds to step 212 for the parsing of the spool data to determine the physical layout and number of pages of the print job(s).

In the case of raw data, and with reference to FIG. 4D, the spool data contains a sequence of print job commands 220a and 220b that describe the overall sheet assembly selections or requirements of the print job (e.g., PJL, PCL, Postscript). The selections, as illustrated by box 222, may include duplex, n-up, booklet, and paper size. The sequence of print job commands may contain additional information on the amount of ink that may be consumed by the print job(s), such as the print quality and resolution (i.e., dpi), also illustrated in box 222.

The remainder of the spool file is parsed for the PDL specific page data 224a and 224b and optional page specific page commands 226a and 226b. The page specific page commands may change the sheet assembly characteristics of the print job. In the case of page description language, such as PCL, postscript and PDF, the page data is parsed to identify the number of data sequences or print commands that will result in an explicit page boundary (e.g., form feed) or an implicit page boundary (e.g., page orientation change). Counting up the number of page boundaries determines the total number of pages of a print job.

Once the accounting information is calculated, and with reference back to FIG. 4C, the amount the print job will cost is determined at step 214. A determination is then made at decision block 216 as to whether or not the charge will be denied due to a lack of funds in the user's account. If it is determined that the charge would be denied, the user may be provided an opportunity to provide additional funds to the user's account. At decision block 218 a determination is made as to whether or not additional funds have been added to the user's account to cover the cost of the print job(s). If additional funds have not been added, the despooling is denied at step 210 and execution returns back to start. Alternatively, if it is determined at decision block 218 that additional funds were added or at decision block 216 that the charge will not be denied, execution proceeds to step 219, where the amount is debited from the user's account and the print job(s) are despooled to the server print processor or port manager and are printed.

In an alternative embodiment, all spooler or print processor authentication and debiting/charging tasks are performed by a print assist processor that may occur anywhere between the driver spooling data to the spooler and the spooler/print processor despooling data to the port manager.

Thus, as discussed herein, the embodiments of the present invention embrace systems and methods for providing print job accounting in a computer system configuration, wherein a cost for a particular print job that is initiated by a computer device and subsequently sent to an available printing device is calculated prior to despooling the print data to the printing device.

While references were made above to Microsoft® operating systems, embodiments of the present invention embrace the use of other operating systems, such as Apple Macintosh® operating systems, Linux® operating system, System V Unix® operating systems, BSD Unix® operating systems, OSF Unix® operating systems, IBM® Mainframe MVS operating system, and other operating systems that may be used for spooling and despooling print data.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In a system that includes a computer device and a printing device, a method for providing print job accounting, the method comprising the steps for:
initiating a print job; and
determining a cost for the print job prior to despooling print data to the printing device, wherein the print data relates to the print job.

2. A method as recited in claim 1, further comprising the steps for:
determining whether there exist sufficient funds in an account of a user to charge the cost to the account; and
if there exists sufficient funds in the account, charging the cost to the account.

3. A method as recited in claim 2, wherein the step for determining whether there exist sufficient funds further comprises the step for authenticating information relating to the account.

4. A method as recited in claim 3, wherein the step for authenticating information comprises the step for receiving information from a user.

5. A method as recited in claim 4, wherein the information received includes a password.

6. A method as recited in claim 3, wherein the step for authenticating information comprises the steps for:
using a print processor to authenticate user information and account information; and
passing the user information and account information to a spooler.

7. A method as recited in claim 6, wherein the step for passing comprises at least one of:
(i) embedding the user and account information in spool data;
(ii) using an application program interface call to pass the user and account information;
(iii) using a spool directory to pass the user and account information; or
(iv) using a registry to pass the user and account information.

8. A method as recited in claim 3, wherein if the information is not authenticated, performing the step for denying a spooling of the print data to the printing device.

9. A method as recited in claim 2, wherein the step for determining a cost for the print job further comprises the step for parsing data.

10. A method as recited in claim 9, wherein the step for parsing data includes the steps for:
determining sheet assembly requirement for the print job;
determining the sheet assembly characteristics of the print job; and
determining the number of pages for the print job.

11. A method as recited in claim 10, wherein the step for determining the number of pages includes counting the number of EMF pathnames.

12. A method as recited in claim 10, wherein the step for determining the number of pages includes identifying the number of page boundaries for the print job.

13. A method as recited in claim 10, wherein the step for determining the number of pages includes counting the number of EMF page file offset links.

14. A method as recited in claim 10, further comprising the steps for:
writing print instructions to a printer driver;
saving print instructions and device context in EMF; and
initiating spooling of journaled data to the spooler.

15. A method as recited in claim 14, further comprising the step for despooling spool data from the spooler to a print processor.

16. A method as recited in claim 10, farther comprising the steps for:
writing print instructions to a printer driver;
rendering print instruction and device context data into printer ready data; and
initiating spooling of printer ready data to the spooler.

17. A method as recited in claim 16, further comprising the step for despooling spool data from the spooler to a print processor.

18. A method as recited in claim 10, further comprising the steps for:
writing print instructions to a printer driver;
saving print instructions and device context in EMF;
spooling EMF data to a client spooler;
despooling EMF data to a client print processor; and
initiating queuing of the print job on a print server.

19. A method as recited in claim 18, further comprising the step for despooling spool data from a server spooler to a server print processor.

20. A method as recited in claim 10, further comprising the steps for:
writing print instructions to a printer driver;
rendering print instructions and device context data into printer ready data;
spooling printer ready data to a client spooler;
despooling printer ready data to a client print processor; and
initiating queuing the print job on a print server.

21. A method as recited in claim 20, further comprising the step for despooling spool data from a server spooler to a server print processor.

22. A system for use in providing print job accounting, the system comprising:
a printing device;
a computer device linked to the printing device, wherein the computer device initiates a print job that is to be printed at the printer device, and wherein a cost for the print job is calculated prior to despooling print data, corresponding to the print job, to the printing device.

23. A system as recited in claim 22, further comprising a network, wherein the network links the computer device to the printing device.

24. A system as recited in claim 23, further comprising a second computer device connected to the network, wherein the second computer device is a server, and wherein the computer device is a client.

25. A system as recited in claim 23, wherein the computer device includes a spooler that is used to parse data in order to calculate the cost for the print job.

26. A system as recited in claim 23, wherein the computer device includes a printer driver that is used to parse data in order to calculate the cost for the print job.

27. A system as recited in claim 23, wherein the computer device includes a print processor that is used to provide job accounting information.

28. A system as recited in claim 23, wherein the computer device includes a spooler that is used to provide print job accounting information.

29. A computer program product for implementing within a computer system a method for providing print job accounting, the computer program product comprising:
a computer readable medium for providing computer program code means utilized to implement the method, wherein the computer program code means is comprised of executable code for implementing the steps for:
initiating a print job; and
determining a cost for the print job prior to despooling print data to the printing device, wherein the print data relates to the print job.

30. A computer program product as recited in claim 29, wherein the computer program code means is further comprised of executable code for implementing the steps for:
determining whether there exist sufficient funds in an account of a user to charge the cost to the account; and
if there exists sufficient finds in the account, charging the cost to the account.

31. A computer program product as recited in claim 30, wherein the computer program code means is further comprised of executable code for implementing the step for authenticating information relating to the account.

32. A computer program product as recited in claim 31, wherein if the information is not authenticated the computer program code means is further comprised of executable code for implementing the step for denying a spooling of the print data to the printing device.

33. A computer program product as recited in claim 32, wherein the computer program code means is further comprised of executable code for implementing the steps for:
determining sheet assembly requirement for the print job;
determining the sheet assembly characteristics of the print job; and
determining the number of pages for the print job.
